(19) United States
(12) Patent Application Publication
(10) Pub. No.: US 2021/0358107 A1
(43) Pub. Date: Nov. 18, 2021

(54) VISUAL INSPECTION CONFIRMATION DEVICE AND NON-TRANSITORY COMPUTER READABLE MEDIUM STORING PROGRAM

(71) Applicant: FUJIFILM BUSINESS INNOVATION CORP., Tokyo (JP)

(72) Inventors: Shingo UCHIHASHI, Kanagawa (JP); Kazunari KOMATSUZAKI, Kanagawa (JP); Kenji SUZUKI, Kanagawa (JP)

(73) Assignee: FUJIFILM BUSINESS INNOVATION CORP., Tokyo (JP)

(21) Appl. No.: 17/109,373

(22) Filed: Dec. 2, 2020

(30) Foreign Application Priority Data
May 18, 2020 (JP) 2020-086627

(51) Int. Cl. G06T 7/00; G06T 7/20; G06T 7/70

(52) U.S. Cl. CPC G06T 7/0004; G06T 7/20; G06T 2207/10016; G06T 2207/30148; G06T 7/70

(57) ABSTRACT

A visual inspection confirmation device includes: a visual field capturing camera that captures a visual field image of an inspector who visually inspects an inspection target; a line of sight information detecting unit that detects line of sight information on the inspector; and a processor configured to execute a program, and identify points of inspection in the inspection target of the inspector in time series from the visual field image based on the line of sight information, compare the identified points of inspection with predetermined work procedure information in time series, and output a result of comparison.

### Cross-Reference to Related Applications

This application is based on and claims priority under 35 USC 119 from Japanese Patent Applications No. 2020-086627 filed on May 18, 2020.

### BACKGROUND

### (i) Technical Field

The present disclosure relates to a visual inspection confirmation device a non-transitory computer readable medium storing a program.

### (ii) Related Art

A technique to support the inspection work by an inspector for an inspection target has been suggested in the past.

Japanese Unexamined Patent Application Publication No. 2013-88291 described a visual inspection support device that improves the work efficiency of visual inspection. The device includes a gaze point calculation unit that calculates the position of a gaze point of an inspector on a captured image of an inspection target by detecting the line of sight of the inspector who inspects the captured image; an inspection area identification unit that, based on the distribution of the gaze point on the captured image, identifies the area visually inspected by the inspector as an inspection area; an inspection area image generation unit that generates an image indicating the inspection area; and an image display unit that displays an image indicating the inspection area and the captured image of the inspection target in an overlapping manner.

Japanese Unexamined Patent Application Publication No. 2012-7985 describes a confirmation task support system that increases the accuracy of a confirmation task. The system includes a head mount display device that can display confirmation information including a confirmation range image which allows at least a confirmation range to be identified; an image capture unit provided in the head mount display device; and an abnormality determination unit that determines abnormal points in the confirmation range by performing image processing using an image captured by the image capture unit.

Japanese Unexamined Patent Application Publication No. 2003-281297 describes a system that supports work by presenting a video which shows a work procedure according to the situation of the work. An information presentation device characterized by having a motion measurement unit, a video information input and an information presentation unit is caused to execute a program of steps characterized by having motion recognition processing, object recognition processing and situation estimation processing, the work situation of a user is thereby estimated from the motion information on the user measured by the motion measurement unit, and the work object of the user recognized from a video captured by the video information input, and appropriate information is presented to the information presentation unit.

### SUMMARY

When an inspector visually inspects an inspection target, the inspector is required to visually inspect points of inspection in accordance with a predetermined work procedure. However, when the inspector is not skillful in the inspection work, an inspection error, such as omission of inspection and an error of the inspection order, may occur.

Aspects of non-limiting embodiments of the present disclosure relate to a technique that, when an inspector visually inspects an inspection target, can confirm that points of inspection have been visually inspected in accordance with a predetermined work procedure.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a visual inspection confirmation device including: a visual field capturing camera that captures a visual field image of an inspector who visually inspects an inspection target; a line of sight information detecting unit that detects line of sight information on the inspector; and a processor configured to, by executing a program, identify points of inspection in the inspection target of the inspector in time series from the visual field image based on the line of sight information, compare the identified points of inspection with predetermined work procedure information in time series, and output a result of comparison.

### BRIEF DESCRIPTION OF THE DRAWINGS

Exemplary embodiment of the present disclosure will be described in detail based on the following figures, wherein:

FIG. 1 is an entire schematic configuration view of an exemplary embodiment;

FIG. 2 is a functional block diagram of the exemplary embodiment;

FIG. 3 is a configuration block diagram of the exemplary embodiment;

FIG. 4 is an extracted explanatory view of a gaze image in the exemplary embodiment;

FIG. 5 is a recognition explanatory view (part 1) of a gaze image in the exemplary embodiment;

FIG. 6 is a recognition explanatory view (part 2) of a gaze image in the exemplary embodiment;

FIG. 7 is a recognition explanatory view (part 3) of a gaze image in the exemplary embodiment;

FIG. 8 is an explanatory view (part 1) of a template image in the exemplary embodiment;

FIG. 9 is an explanatory view (part 2) of the template image in the exemplary embodiment;

FIGS. 10A and 10B are explanatory views illustrating a sudden change of a visual field captured image in the exemplary embodiment;

FIG. 11 is an explanatory view illustrating a sudden change of the direction of a line of sight in the exemplary embodiment;

FIG. 12 is a schematic explanatory chart of time series comparison in the exemplary embodiment; and

FIG. 13 is a processing flowchart of the exemplary embodiment.

### DETAILED DESCRIPTION

Hereinafter, an exemplary embodiment of the present disclosure will be described with reference to the drawings.

### <Configuration>

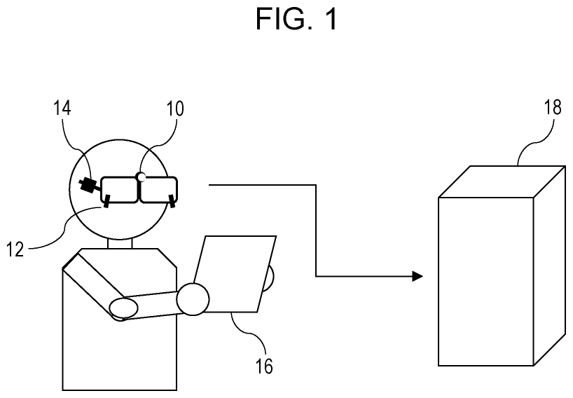

FIG. 1 is an entire schematic configuration view of a visual inspection confirmation device in the exemplary embodiment. The visual inspection confirmation device includes a visual field capturing camera 10 worn by an inspector, a line of sight detection camera 12, an acceleration sensor 14, and a server computer 18 that receives and processes information from the visual field capturing camera 10, the line of sight detection camera 12, and the acceleration sensor 14.

The inspector visually recognizes an inspection target 16, and makes visual inspection to confirm whether it is normal. The visual inspection is normally made based on predetermined work procedure information. The work procedure information is configurated by procedures and the contents thereof. Naturally, the work procedure information is set according to the inspection target 16. For instance, when the inspection target 16 is a semiconductor substrate (board), the work procedure information is set as follows, for instance.

### <Procedure> <Instruction Contents>

1. Hold the board in a standard direction.

2. Inspect area 1 visually to confirm the absence of solder peeling.

3. Inspect area 2 visually to confirm the absence of solder peeling.

12. Rotate the board to face an external terminal.

13. The inspector who visually inspects area 3 to confirm the absence of solder peeling holds the inspection target 16 in accordance with such work procedure information, and moves the line of sight to a point of inspection and makes visual inspection.

The visual field capturing camera 10 is disposed, for instance, at an approximately central position of the glasses worn by an inspector, and captures an image (visual field image) in the visual field range of the inspector. The visual field capturing camera 10 sends the captured visual field image (visual field captured image) to a server computer 18 via a cable or wirelessly. The visual field capturing camera 10 is fixed to the head of the inspector, and captures a range as the visual field range, the range being visible by the inspector who moves the eyeballs up and down, and right and left. Basically, it is desirable for the visual field capturing camera 10 to capture the entire range visible by moving the inspector's eyeballs up and down, and right and left. However, capturing of certain part of the entire range, particularly, the area for an extreme ocular position may be restricted. The average visual field range of skillful inspectors may be calculated statistically, and the average visual field range may be used as the image capturing range.

The line of sight detection camera 12 is disposed, for instance, at a predetermined position of the glasses worn by the inspector, and detects the motion of the eyeballs (motion of the line of sight) of the inspector. The line of sight detection camera 12 sends the detected motion of the line of sight to the server computer 18 as the line of sight information via a cable or wirelessly. The line of sight detection camera 12 analyzes, for instance, the video of the line of sight detection camera which captures a motion of the eyes of the inspector, and detects a motion of the line of sight of the inspector. Instead of the line of sight detection camera 12, another device which detects the motion of the eyes of the checker may be used. For instance, light radiates to the corneas of the inspector, and a motion of the line of sight of the inspector may be detected by analyzing a reflected light pattern. Basically, an unmovable part (reference point) and a movable part (movable point) of the eyes are detected, and a motion of the line of sight of the inspector is detected based on the position of the movable point relative to the reference point. The inner corner of each eye may be used as the reference point, and the iris of each eye may be used as the movable point. The corneal reflex of each eye may be used as the reference point, and the pupil of each eye may be used as the movable point.

The line of sight information of the inspector detected by the line of sight detection camera 12 is used to identify the area seen by the inspector in the visual field captured image obtained by the visual field capturing camera 10, in other words, the point of inspection of the inspector. Therefore, it is necessary that the positional relationship between the visual field captured image and the visual field information be identified in advance. The relative positional relationship between the visual field capturing camera 10 and the line of sight detection camera 12 is fixed, and the positional relationship between the visual field captured image and the direction of the line of sight of the inspector identified by the line of sight information is corrected (calibrated) in advance so as to achieve one-to-one correspondence.

The acceleration sensor 14 is disposed at a predetermined position of the glasses worn by the inspector, for instance, and detects the motion (acceleration) of the head of the inspector. The acceleration sensor 14 sends the detected motion of the head to the server computer 18 via a cable or wirelessly.

The server computer 18 receives the visual field captured image from the visual field capturing camera 10, line of sight information indicating the direction of the line of sight from the line of sight detection camera 12, and an acceleration signal from the acceleration sensor 14 indicating the motion of the head of the inspector, and executes various types of processing according to a program, thereby determining whether the visual inspection of the inspector is correct. That is, the server computer identifies which point of inspection of the inspection target 16 is seen by the inspector in time series, based on the visual field captured image from the visual field capturing camera 10, and the line of sight information indicating the direction of the line of sight from the line of sight detection camera 12, checks the time series recognized result against predetermined work procedure information, and determines whether the time series recognized result matches the work procedure defined in the work procedure information.

In addition, based on the acceleration signal from the acceleration sensor 14, the server computer 18 determines whether the time series identification processing is performed as to which point of inspection of the inspection target 16 is seen by the inspector. Specifically, based on the acceleration signal, the time series identification processing is not performed when it is not appropriate to perform the time series identification processing, or even when the time series identification processing itself is performed, the recognized result is not used to check against the work procedure information. Specifically, when the motion of the head of the inspector indicated by the acceleration signal is greater than or equal to a predetermined threshold, the identification processing is not performed. Furthermore, the server computer 18 detects the posture of the head of the inspector based on the acceleration signal, and performs the time series identification processing additionally based on the information on the direction in which the inspection target 16 is seen by the inspector.

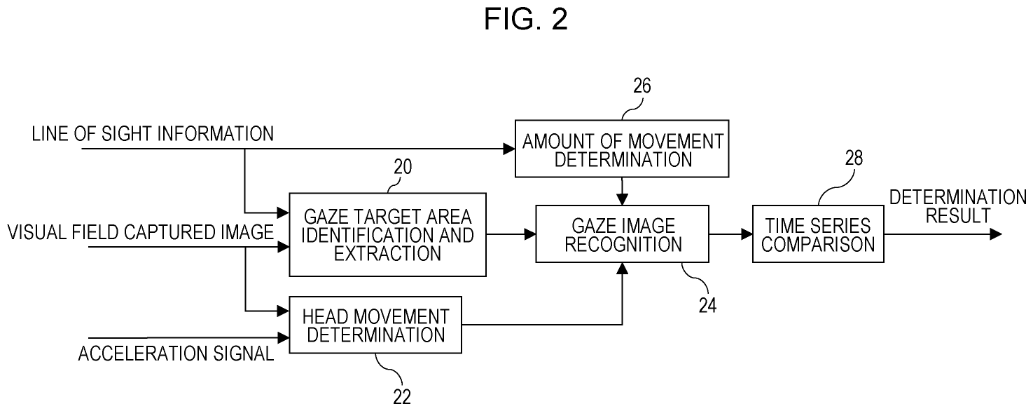

FIG. 2 illustrates a functional block diagram of the server computer 18. The server computer 18 includes, as the functional blocks, a gaze target area identification and extraction unit 20, a head motion determination unit 22, a gaze image recognition unit 24, an amount of movement determination unit 26, and a time series comparison unit 28.

The gaze target area identification and extraction unit 20 identifies and extracts an image (gaze image) probably gazed by the inspector in the visual field captured image, based on the input visual field captured image and line of sight information. When the line of sight information is expressed in terms of azimuth θ and elevation angle φ, for instance, the coordinates on the visual field captured image are identified from the positional relationship between the visual field capturing camera 10 and the position of the eyes of the inspector. Then, an image area in a predetermined size, for instance, fixed width W and height H with the center at the identified coordinates (line of sight coordinates) can be extracted as the gaze image. The gaze target area identification and extraction unit 20 sends the extracted gaze image to the gaze image recognition unit 24.

The head motion determination unit 22 detects the posture and motion of the head of the inspector based on the input acceleration signal, and sends the posture and motion to the gaze image recognition unit 24.

The amount of movement determination unit 26 detects the amount of movement of the line of sight of the inspector based on the input line of sight information, and sends the amount of movement to the gaze image recognition unit 24.

The gaze image recognition unit 24 inputs the gaze image extracted by the gaze target area identification and extraction unit 20, the amount of movement of the line of sight detected by the amount of movement determination unit 26, and the posture and motion of the head of the inspector detected by the head motion determination unit 22, and uses these pieces of information to sequentially recognize a point of inspection, corresponding to the gaze image, in the inspection target 16 in time series. Specifically, the gaze image recognition unit 24 repeatedly inputs the gaze image extracted by the gaze target area identification and extraction unit 20, the amount of movement of the line of sight detected by the amount of movement determination unit 26, and the posture and motion of the head of the inspector detected by the head motion determination unit 22 with a predetermined control cycle T, and uses these pieces of information to sequentially recognize a point of inspection, corresponding to the gaze image, in the inspection target 16 with the control cycle T. For instance, at time t1, the gaze image corresponds to the area 1 of the inspection target 16, at time t2, the gaze image corresponds to the area 2 of the inspection target 16, and at time t3, the gaze image corresponds to the area 3 of the inspection target 16, etc.

When recognizing the point of inspection, corresponding to the gaze image, in the inspection target 16, the gaze image recognition unit 24 also recognizes the direction in which the inspector sees. Also, it may be not possible to recognize a corresponding point of inspection with only the gaze image in a single frame, thus a corresponding point of inspection in the inspection target 16 may be recognized using the gaze image in consecutive frames. It is needless to say that in this case, the gaze image is assumed to indicate the same target in the consecutive frames. The recognition processing by the gaze image recognition unit 24 will be further described below. The gaze image recognition unit 24 sends the time series recognized result to the time series comparison unit 28.

The time series comparison unit 28 checks the time series recognized result against the work procedure information, and determines whether the time series recognized result matches the work procedure. The time series comparison unit 28 outputs a result of determination: OK for matching, NG for unmatching. It is to be noted that in each time series recognized result, matching with a certain rate or higher may be determined to be OK, and matching with lower than a certain rate may be determined to be NG.

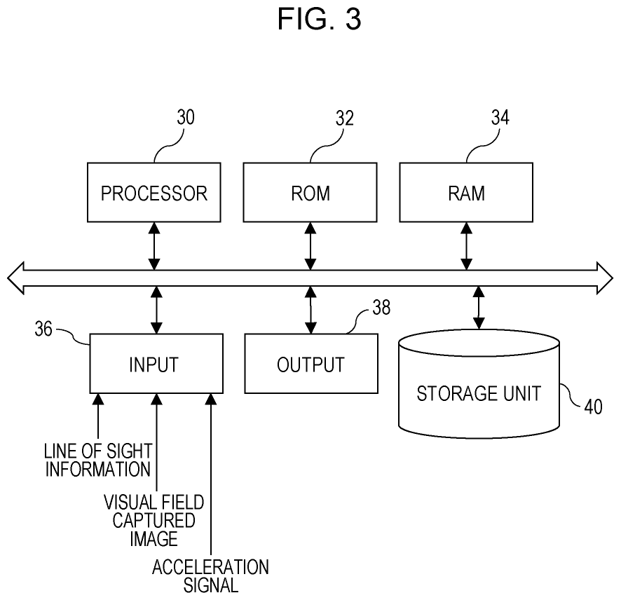

FIG. 3 illustrates a configuration block diagram of the server computer 18. The server computer 18 includes a processor 30, a ROM 32, a RAM 34, an input 36, an output 38 and a storage unit 40.

The processor 30 reads a processing program stored in the ROM 32 or another program memory, and executes the program using the RAM 34 as a working memory, thereby implementing the gaze target area identification and extraction unit 20, the head motion determination unit 22, the gaze image recognition unit 24, the amount of movement determination unit 26, and the time series comparison unit 28 in FIG. 2. The types of processing in the processor 30 are listed as follows.
The processing of extraction of a gaze image gazed by the inspector from the visual field captured image.
The time series recognition processing for a gaze image.
The check processing for the time series recognized result against the work procedure information.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The input 36 is configurated by a keyboard and a mouse, a communication interface, and receives an input of a visual field captured image, line of sight information, and an acceleration signal. The input 36 may receive input of these pieces of information with a dedicated line, or may receive input via the Internet. It is desirable that these pieces of information be time-synchronized to each other.

The output 38 is configurated by a display unit and a communication interface, and displays a result of determination by the processor 30 or outputs the result to an external device. For instance, the output 38 outputs a result of determination to an external management unit through a dedicated line or the Internet or the like. An administrator can manage the visual inspection of an inspector by visually recognizing the result of determination outputted to the management unit.

The storage unit 40 stores the image of each point of inspection in the inspection target 16, results of determination, and predetermined work procedure information. The image of each point of inspection in the inspection target 16 is used to recognize a gaze image as a template image. The processor 30 checks the template images stored in the storage unit 40 against the gaze image by pattern matching, and recognizes that the gaze image corresponds to which point of inspection of the inspection target 16. It is to be noted that a neural network may be trained through machine learning, and a gaze image may be recognized using the trained neural network. In addition, the processor 30 retrieves the work procedure information stored in the storage unit 40, and checks the work procedure information against the time series recognized result and makes determination.

Next, in the exemplary embodiment, the processing performed by the processor 30 will be described in greater detail.

### <Recognition Processing for Gaze Image>

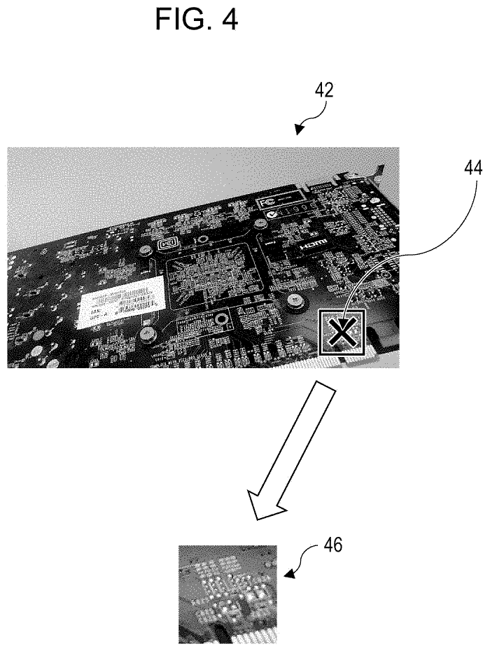

FIG. 4 schematically illustrates the extraction processing for a gaze image performed by the processor 30. The processor 30 receives input of a visual field captured image 42 as well as visual field information at the same time. The coordinate position (as shown by X symbol in FIG. 4) 44 of the line of sight of the inspector in the visual field captured image 42 is identified from azimuth θ and elevation angle 100 as the visual field information, and the image area having fixed width W and height H with the center at the coordinate position 44 is extracted as a gaze image 46. Such extraction processing is repeatedly performed with the predetermined control cycle T, and the time series gaze image 46 is extracted.

It is to be noted that the fixed width W and height H are basically fixed values. However, the values may be adjusted as needed according to the inspector.

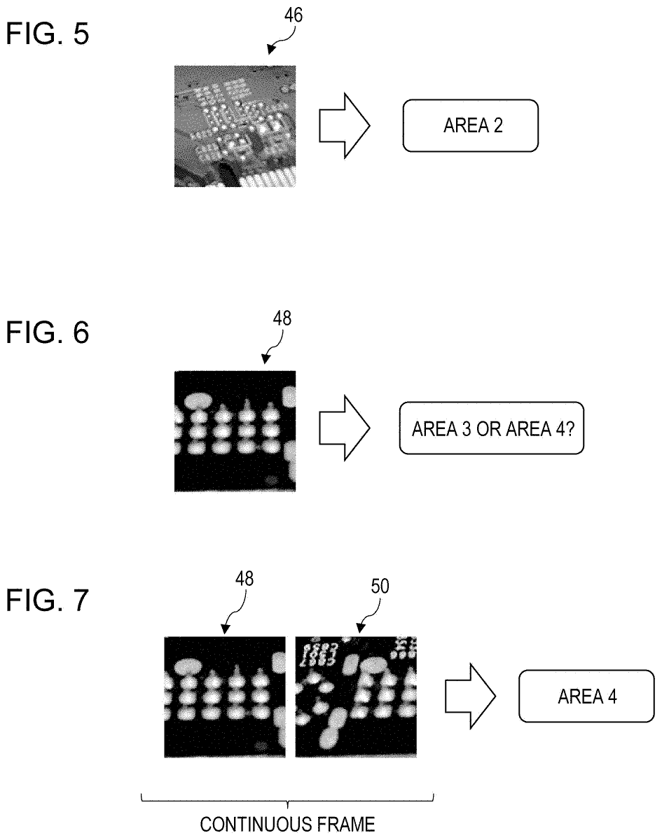

FIG. 5, FIG. 6, and FIG. 7 schematically illustrate the recognition processing for a gaze image.

When the gaze image 46 is extracted in FIG. 5, the processor 30 checks the gaze image against the template images, and recognizes that the gaze image corresponds to which point of inspection of the inspection target 16. Multiple template images are prepared for each point of inspection in the inspection target 16. These multiple images are obtained by capturing an image at each point of inspection with varied direction and illumination conditions. The gaze image 46 is checked against the template images, and when the template image with a matching pattern is the “area 2” of the inspection target 16, the gaze image 46 is recognized as the “area 2”.

However, as illustrated in FIG. 6, even when the gaze image 48 is checked against the template images, a corresponding point of inspection may not be recognized. In FIG. 6, the gaze image 48 has substantially the same degree of pattern matching with each of the “area 3” and the “area 4”, which indicates that a corresponding point of inspection cannot be recognized. In such a case, an image in consecutive frames rather than an image in a single frame is used as each of the gaze image 48 and the template image, and the gaze image 48 in consecutive frames is checked against the template images in consecutive frames.

FIG. 7 shows that as a consequence of checking the gaze images 48, 50 in consecutive frames against consecutive template images, the gaze images are recognized as the “area 4”. The gaze images 48, 50 are particularly effective when the inspector sees the same point of inspection of the inspection target 16 in different directions in succession.

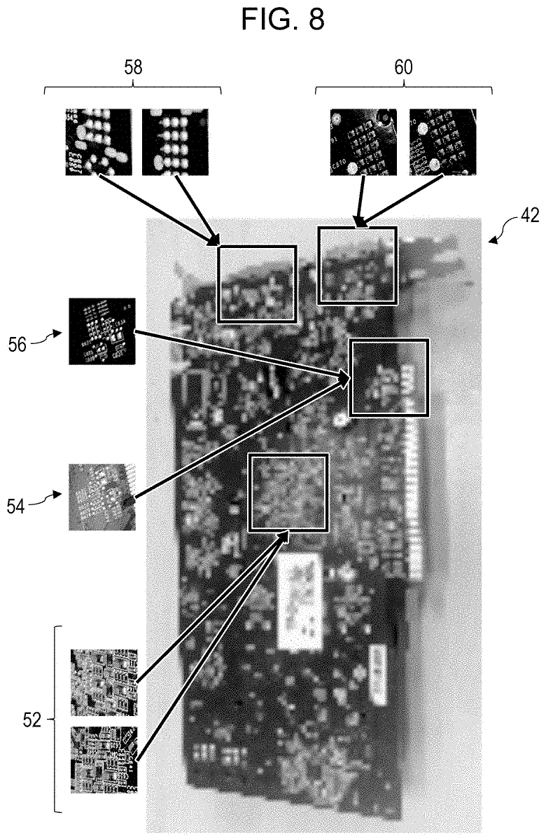

FIG. 8 illustrates an example of a template image for each point of inspection of the inspection target 16. In the image of the inspection target 16 present in the visual field captured image 42, one or more template images are prepared for each predetermined point of inspection. In FIG. 8, template images 52 to 60 are exemplified, and specifically,

Template image 52: the direction of “area 1” is N.

Template image 54: the direction of “area 2” is S.

Template image 56: the direction of “area 2” is E.

Template image 58: the direction of “area 3” is E.

Template image 60: the direction of “area 4” is E.

Here, the directions N, S, E show the respective images when the inspection target 16 is seen from the north side, the south side, the east side, where a certain direction is the reference north side. Also, two images configurating the template image 52 indicate that even when the direction of the “area 1” is the same N, the respective directions N1, N2 are slightly different.

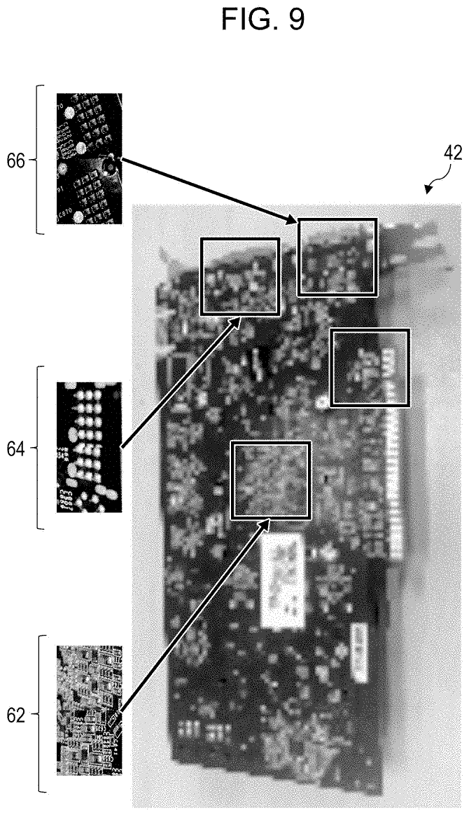

FIG. 9 illustrates another example of a template image for each point of inspection of the inspection target 16. In the image of the inspection target 16 present in the visual field captured image 42, a template image in consecutive frames is prepared for each predetermined point of inspection. In FIG. 9, template images 62 to 66 are exemplified, and specifically,

Template image 62: consecutive frames with the direction N of the “area 1”.

Template image 64: consecutive frames with the direction E of the “area 3”.

Template image 66: consecutive frames with the direction E of the “area 4”.

In FIG. 9, two frames are exemplified as the consecutive frames. However, three of more frames may be used as needed.

The processor 30 checks the gaze image 46 against the template images, and recognizes that the gaze image 46 corresponds to which point of inspection of the inspection target 16. However, instead of this, the processor 30 checks the gaze image 46 against the template images, and may recognize that the gaze image 46 corresponds to which component (such as parts) present in a point of inspection. In this case, an image of a component, such as a resistor, a capacitor, and an IC, may be used as a template image.

Furthermore, when the processor 30 recognizes that the gaze image 46 corresponds to its point of inspection or which component, a trained neural network (NN), specifically, a deep neural network (DNN) may be used. The training data used for learning is given as pairs of a multidimensional vector for the input to the DNN and a corresponding target value for the output of the DNN. The DNN may be feed forward in which a signal propagates sequentially from an input layer to an output layer. The DNN may be implemented by a GPU (graphics processing unit) or an FPGA, or collaboration between these and a CPU, however, this is not always the case. The DNN is stored in the storage unit 40. Also, the storage unit 40 stores a processing program to be executed by the processor 30.

The processor 30 processes an input signal using the DNN stored in the storage unit 40, and outputs a result of processing as an output signal. The processor 30 is configurated by, for instance, a GPU (Graphics Processing Unit). As the processor 30, GPGPU (General-Purpose computing on Graphics Processing Units, general-purpose computation by a GPU) may be used. The DNN includes an input layer, an intermediate layer, and an output layer. An input signal is inputted to the input layer. The intermediate layer includes multiple layers, and processes the input signal sequentially. The output layer outputs an output signal based on the output from the intermediate layer. Each layer includes multiple neurons (units), which become activated neurons by an activated function f.

As the neurons of layer 1, a₁¹, a₂¹, . . . , aₘ¹ are provided. Let the weight vector between layer 1 and layer 1+1 be w¹=[w₁¹, w₂¹, . . . , wₘ¹]^{T}, then the neurons of layer 1+1 are given by

a₁¹⁺¹=f((w₁¹)^{T}a¹)

aₘ¹⁺¹=f((wₘ¹)^{T}a¹), where, the bias terms are omitted as zero.

For the learning of the DNN, learning data is inputted thereto, and the loss is calculated by finding the difference between the target value corresponding to the learning data and the output value. The calculated loss is propagated backward in the DNN, and the parameters of the DNN, namely, the weight vectors are adjusted. The next learning data is inputted to the DNN with adjusted weights, and the loss is calculated again by finding the difference between the newly outputted output value and the target value. The re-calculated loss is propagated backward in the DNN, and the weight vectors of the DNN are re-adjusted. The weight vectors of the DNN are optimized by repeating the above-described processing. The weight vectors are initialized to proper values at first, and subsequently, are converged to optimal values by repeating the learning. The weight vectors are converged to optimal values, thus for input of a gaze image to the DNN, the DNN is trained so as to output which point of inspection or which component in the inspection target 16 corresponds to the gaze image.

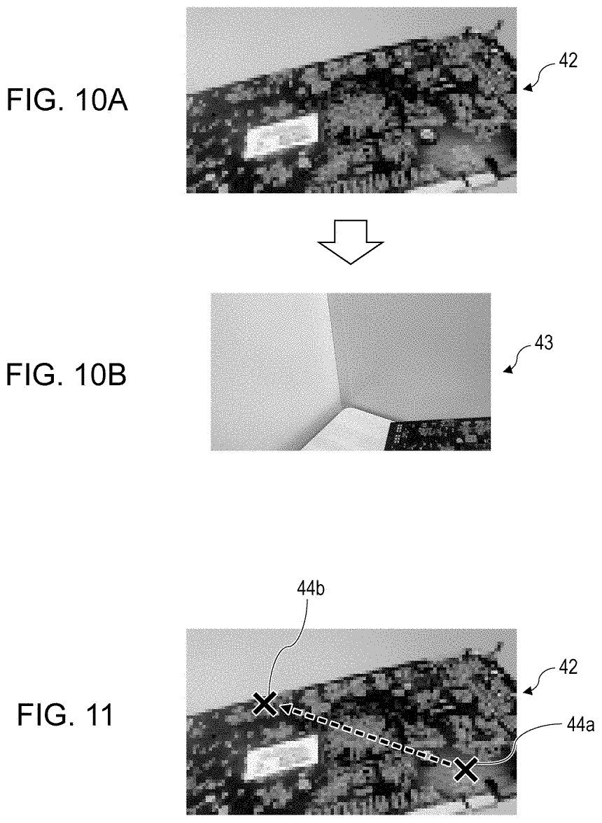

FIGS. 10A and 10B schematically illustrate an example when the recognition processing for a gaze image is not performed by the processor 30. FIGS. 10A and 10B illustrate the case where the head of the inspector is significantly moved in a short time, and the visual field captured image 42 has changed in a short time. FIG. 10A illustrates the visual field captured image 42 at timing t1 with the control cycle T, and FIG. 10B illustrates a visual field captured image 43 at the next timing t1+T after the control cycle T. Although an inspection target is present in the visual field captured image 42, an inspection target is not present in the visual field captured image 43. Like this, when the visual field captured image 42 has significantly changed in a short time, the processor 30 suspends extraction of a gaze image and recognition processing for a gaze image. The processing can be simplified and false recognition can be prevented by suspending the extraction of a gaze image and the recognition processing for a gaze image.

It is to be noted that when significant change of the visual field captured image 42 continues for a certain period of time, extraction of all gaze images and recognition processing for all gaze images are suspended in the period of time. Specifically, the processor 30 compares the amount of change (value of the difference image) in the visual field captured image 42 with a threshold, and for a period of time with the threshold or greater, suspends the extraction of a gaze image and the recognition processing for a gaze image.

FIG. 11 illustrates the case where the direction of the line of sight of the inspector has significantly changed in a short time. FIG. 11 illustrates coordinates 44a of the line of sight of the visual field captured image 42 at timing t1 in the control cycle T, and coordinates 44b of the line of sight at the next timing t1+T after the control cycle T. For visual inspection of a point of inspection, it is necessary to see the point of inspection for at least a certain period of time. However, when the line of sight of the inspector moves and the line of sight deviates from the point of inspection in less the certain period of time, the processor 30 suspends the extraction of a gaze image and the recognition processing for a gaze image. The processing can be simplified and false recognition can be prevented by suspending the extraction of a gaze image and the recognition processing for a gaze image. Specifically, the processor 30 compares the amount of change in the coordinates of the line of sight with a threshold, and for a period of time with the threshold or greater, suspends the extraction of a gaze image and the recognition processing for a gaze image.

It is to be noted that in FIG. 11, in a special situation, for instance, when the inspector is particularly skillful in the visual inspection work, and can inspect the point inspection in less than an average visual inspection time, the extraction of a gaze image and the recognition processing for a gaze image may be performed at the coordinates 44a as well as at the coordinates 44b of the line of sight.

Also, when the visual field captured image 42 has significantly changed in FIG. 10, or the direction of the line of sight has significantly changed in FIG. 11, the extraction of a gaze image and the recognition processing for a gaze image are suspended. However, in addition to this, in the case or in a period of time where the acceleration indicated by the acceleration signal from the acceleration sensor 14, in other words, the amount of motion of the head of the inspector is high and exceeds a threshold, the extraction of a gaze image and the recognition processing for a gaze image may be suspended.

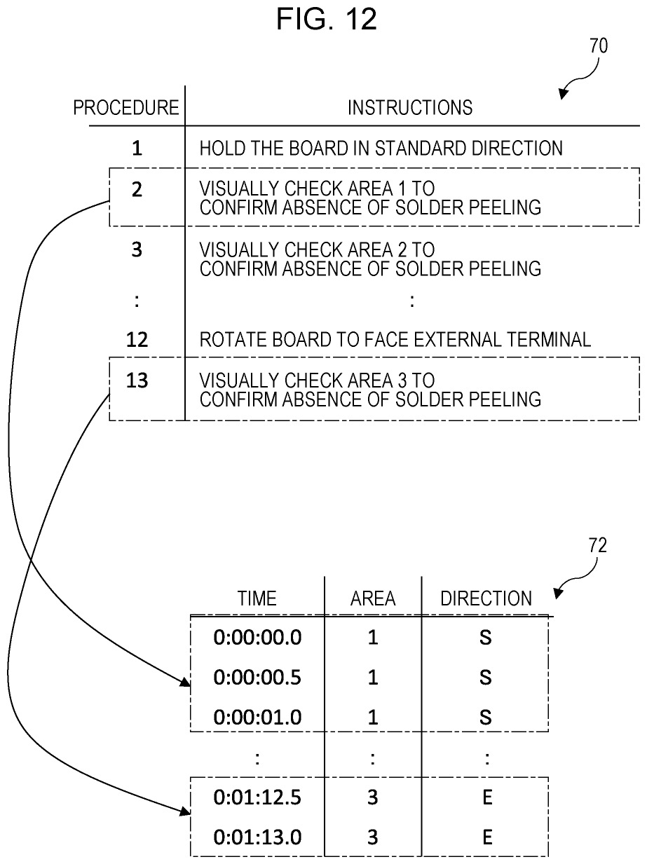

FIG. 12 schematically illustrates the time series comparison processing performed by the processor 30. The processor 30 checks a recognized result 72 of a gaze image against work procedure information 70 which is prepared in advance and stored in the storage unit 40. For instance, the work procedure information 70 is assumed to be as follows:

### <Procedure> <Instruction Contents>

1 Hold the board in a standard direction.

2 Visually check the area 1 to confirm the absence of solder peeling.

3 Visually check the area 2 to confirm the absence of solder peeling.

12 Rotate the board to face an external terminal.

13 Visually check the area 3 to confirm the absence of solder peeling.

Also, the recognized result 72 is assumed to be as follows:

| Time | Area | Direction |
|---|---|---|
| 0:00:00.0 | 1 | S |
| 0:00:00.5 | 1 | S |
| 0:00:01.0 | 1 | S |
| * | | |
| * | | |
| * | | |
| 0:01:12.5 | 3 | E |
| 0:01:13.0 | 3 | E |

The recognized result 72 recognizes that the inspector sees the area 1 in the direction of S during the time from 0:00:00.0 to time 0:00:01.0, and this matches the following information in the work procedure information 70.

### <Procedure> <Instruction Contents>

2 Visually check the area 1 to confirm the absence of solder peeling.

Thus, the processor 30 determines that the relevant part of the recognized result 72 matches the work procedure information 70.

The recognized result 72 recognizes that the inspector sees the area 3 in the direction of E during time 0:01:12.5 to time 0:01:13.0, and this matches the following information in the work procedure information 70.

### <Procedure> <Instruction Contents>

Visually check the area 3 to confirm the absence of solder peeling.

Thus, the processor 30 determines that the relevant part of the recognized result 72 matches the work procedure information 70.

Here, it is to be noted that the processor 30 checks the time series recognized result 72 against the work procedure information 70. That is,

| | | |
|---|---|---|
| 0:01:12.5 | 3 | E |
| 0:01:13.0 | 3 | E |

are present later than

| | | |
|---|---|---|
| 0:00:00.0 | 1 | S |
| 0:00:00.5 | 1 | S |
| 0:00:01.0 | 1 | S |

Therefore, in the work procedure information 70, when

| | | |
|---|---|---|
| 0:00:00.0 | 1 | S |
| 0:00:00.5 | 1 | S |
| 0:00:01.0 | 1 | S |

are recognized as the following data

### <Procedure> <Instruction Contents>

2 Visually check the area 1 to confirm the absence of solder peeling,

| | | |
|---|---|---|
| 0:01:12.5 | 3 | E |
| 0:01:13.0 | 3 | E |

have to be part of the procedure 3 and subsequent procedures. When checking the following data with the work procedure information 70

| | | |
|---|---|---|
| 0:01:12.5 | 3 | E |
| 0:01:13.0 | 3 | E, |

the processor 30 refers to the procedure 3 and subsequent procedures as well as the instruction contents to check both the procedures and the instruction contents.

Also, when the time series recognized result 72 is area 1→area 3→area 2, and the time series work procedure information 70 is area 1→area 2→area 3, the processor 30 determines that area 1 of the recognized result 72 matches the work procedure information 70, but other areas do not match the work procedure information 70.

It is to be noted that in addition to the procedures and the instruction contents as illustrated in FIG. 12, each of the pieces of work procedure information 70 may be defined as a procedure, and an area and its direction. For instance,

| <Procedure> | <Area and its direction> |
|---|---|
| 1 | 1 S |
| 2 | 2 S |
| 3 | 3 S |
| 4 | 3 E |
| 5 | 4 E |
| 6 | 4 W |
| 7 | 5 W |
| * | |
| * | |
| * | |

Here, “1 S” means that “area 1 is seen from the direction S”. The recognized result 72 is also a time series recognized result, and may be a recognized result having visual inspection time data. For instance, the visual inspection time data is the following data.

(1 S, 2.5 seconds)

(unknown, 0.5 seconds)

(1 E, 0.5 seconds)

(2 S, 3 seconds)

(3 S, 1.5 seconds)

(unknown, 0.5 seconds)

(3 E, 2 seconds)

Here, (unknown, 0.5 seconds) means that extraction of a gaze image and recognition processing of the gaze image have not been performed and suspended, or the recognition processing itself has been performed but a point of inspection could not be recognized. In addition, (1 S, 2.5 seconds) means that area 1 has been seen from the direction S continuously for 2.5 seconds.

When the recognized result 72 is checked with the work procedure information 70, attention is paid to time length data of the recognized result 72, and in the case where the time length is less that a predetermined first threshold time, the data is not used as the recognized result 72, and is not checked with the work procedure information 70. For instance, the first threshold time is set to 1 second, and a recognized result having a time length less than 1 second is not used. Thus, instantaneous noise is reduced, and checking accuracy can be ensured.

In addition, when the recognized result 72 is checked with the work procedure information 70, attention is paid to time length data of the recognized result 72, and in the case where the time length is greater than a predetermined second threshold time, the data is not used as the recognized result 72, and is not checked with the work procedure information 70. For instance, the second threshold time is set to 5 seconds, and a recognized result having a time length greater than 5 seconds is not used. Thus, irregular gaze of the inspector can be excluded.

In short, of the recognized result 72, only the recognized result having data of time length greater than or equal to the first threshold time and less than or equal to the second threshold time is checked with the work procedure information 70. As a result, when the following data is extracted as the effective recognized result 72
(1 S, 2.5 seconds)
(2 S, 3 seconds)
(3 S, 1.5 seconds)
(3 E, 2 seconds),
the time series recognized result 72 is checked with the work procedure information 70. In this case, the processor 30 determines that

| | |
|---|---|
| <Procedure> | <Area and its direction> |

(1 S, 2.5 seconds) matches

| | |
|---|---|
| 1 | 1 S, |

(2 S, 3 seconds) matches

| | |
|---|---|
| 2 | 2 S, |

(3 S, 1.5 seconds) matches

| | |
|---|---|
| 3 | 3 S, |

(3 E, 2 seconds) matches

| | |
|---|---|
| 4 | 3 E. |

In addition, each of the pieces of work procedure information 70 may be defined as a component to be visually inspected and its direction instead of an area or along with an area. For instance,

| <Procedure> | <Component and its direction> |
|---|---|
| 1 | resistor a in area 1, S |
| 2 | resistor b in area 1, S |
| 3 | capacitor a in area 2, S |
| 4 | capacitor b in area 2, E |
| 5 | IC a in area 3, E |
| 6 | IC b in area 3, W |
| 7 | IC c in area 4, W |
| * | |
| * | |
| * | |

Here, “resistor a in area 1, S” means that “the component called resistor a present in area 1 is seen from the direction S”. Similarly, “IC a in area 3, E” means that “the component called IC a present in area 3 is seen from the direction E”. The recognized result 72 is a time series recognized result, and may be a recognized result having component data. For instance,

(resistor a 1 S, 2.5 seconds)

(unknown, 0.5 seconds)

(resistance b 1 E, 0.5 seconds)

(capacitor a 2 S, 3 seconds)

(capacitor b 2 S, 1.5 seconds)

(unknown, 0.5 seconds)

(Ica 3 E, 2 seconds)

Here, (resistor a 1 S, 2.5 seconds), means that “resistor a in area 1 has been seen from the direction S for 2.5 seconds”.

The processor 30 checks the recognized result 72 with the work procedure information 70, and determines that the visual inspection is OK when a certain rate or higher of the work procedure defined in the work procedure information 70 matches the recognized result 72. The certain rate may be set optionally, and, for instance, may be set to 80%. The certain rate, in other words, the passing line may be adaptively adjusted according to the inspector and/or the type of the inspection target 16.

Alternatively, the processor 30 checks the recognized result 72 with the work procedure information 70, and may output at least one of matched work procedures and unmatched work procedures. For instance, when the work procedures 2, 4 are unmatched, the processor 30 outputs these work procedures as “deviation procedures”. In this manner, a visual inspection confirmer can easily confirm which procedures have deviated by an inspector in the visual inspection. When the same work procedure has deviated by multiple inspectors, the work procedure information 70 itself is determined to be inappropriate, and it is possible to work on improvement, such as reviewing, of the work procedure information 70.

Furthermore, the processor 30 checks the recognized result 72 with the work procedure information 70, and may output a matching rate, or an accumulated value or a statistical value other than the matching rate.

### <Processing Flowchart>

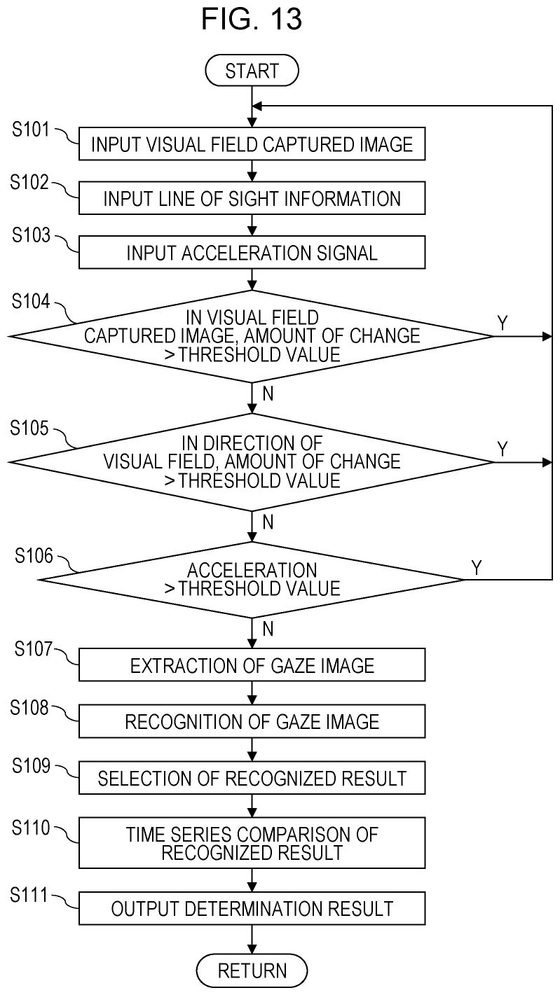

FIG. 13 illustrates the processing flowchart of the exemplary embodiment. The processing flowchart shows the processing of the processor 30 performed by reading and executing a processing program.

First, a visual field captured image, line of sight information, and an acceleration signal are sequentially inputted (S101 to S103).

Next, the processor 30 determines whether the amount of change in the visual field captured image, that is, the amount of difference between difference images of the visual field captured image in the control cycle T exceeds a threshold (S104). When the amount of difference exceeds the threshold, and the amount of change in the visual field captured image is large (YES in S104), extraction of a gaze image and recognition processing of the gaze image are not performed.

When the amount of change in the visual field captured image is less than the threshold (NO in S104), the processor 30 then determines whether the amount of change in the direction of the line of sight, that is, the amount of change in the direction of the line of sight in the control cycle T exceeds a threshold (S105). When the amount of change exceeds the threshold, and the amount of change in the direction of the line of sight is large (YES in S105), extraction of a gaze image and recognition processing of the gaze image are not performed.

When the amount of change in the direction of the line of sight is less than the threshold (NO in S105), the processor 30 then determines whether the acceleration of a hand exceeds a threshold (S106). When the magnitude of the acceleration exceeds the threshold, and the head of the inspector is significantly moved (YES in S106), extraction of a gaze image and recognition processing of the gaze image are not performed.

When each of the visual field captured image, the direction of the line of sight, and the magnitude of acceleration is less than a corresponding threshold, the processor 30 determines that each of the visual field, the line of sight, and the motion of the head of the inspector is in a corresponding appropriate range, and extracts a gaze image of the inspector from the visual field captured image and the coordinates of the line of sight (S107).

After extracting a gaze image, the processor 30 compares the extracted image with the template images of the inspection target 16, and recognizes the extracted image by pattern matching (S108). Alternatively, the processor 30 recognizes the extracted image using a trained NN or DNN. The point of inspection seen by the inspector and its visual direction are determined by the recognition of the extracted image. Although the point of inspection can be determined as an area, components in the area may be identified. Alternatively, in addition to the point of inspection and its direction, a continuous visual inspection time may be determined.

After having recognized the gaze image, the processor 30 selects (filters) a recognized result according to a predetermined criterion (S109). Specifically, when the recognized result is unknown (unrecognizable) or the continuous visual inspection time is less than the first threshold time, or the continuous visual inspection time is greater than the second threshold time, the recognized result is excluded. Here, the first threshold time<the second threshold time.

After having selected (filtered) a recognized result, the processor 30 reads work procedure information from the storage unit 40, and compares and checks the selected time series recognized result with the work procedure information (S110). The processor 30 then determines whether the visual inspection of the inspector is in accordance with the work procedure, and outputs a result (S111). Specifically, as a result of the checking, when the time series recognized result matches the work procedure with a certain rate or higher, the processor 30 determines and outputs OK, and when the time series recognized result matches the work procedure with lower than the certain rate, the processor 30 determines and outputs NG. The processor 30 may extract and output an unmatched work procedure as a deviation work procedure. For instance,
inspector A: 80% of matching rate, OK
inspector B: 60% of matching rate, NG, procedures 2, 4.

Here, the “procedures 2, 4” of the inspector B indicate the work procedures which have deviated.

As already described, even when determination of YES is made in S104, a gaze image may be individually extracted from the images before and after the direction of the line of sight is changed. Also, similarly, even when determination of NO is made in S105, a gaze image may be individually extracted from the images before and after the acceleration is changed.

As described above, in the exemplary embodiment, when an inspector visually inspects an inspection target, it is possible to confirm that points of inspection have been visually inspected in accordance with a predetermined work procedure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A visual inspection confirmation device comprising:
a visual field capturing camera that captures a visual field image of an inspector who visually inspects an inspection target;
a line of sight information detecting unit that detects line of sight information on the inspector; and
a processor configured to, by executing a program,
identify points of inspection in the inspection target of the inspector in time series from the visual field image based on the line of sight information,
compare the identified points of inspection with predetermined work procedure information in time series, and
output a result of comparison.

2. The visual inspection confirmation device according to claim 1, wherein the processor is configured to identify components at the points of inspection using an image of the inspection target and the line of sight information.

3. The visual inspection confirmation device according to claim 1, further comprising
a motion detector that detects motion of a head of the inspector,
wherein the processor is configured to identify the points of inspection of the inspection target based on the motion of the head of the inspector.

4. The visual inspection confirmation device according to claim 3, wherein the processor is configured to identify the points of inspection of the inspection target based on a visual direction of the inspector toward the inspection target.

5. The visual inspection confirmation device according to claim 3, wherein the processor is configured to
identify the points of inspection of the inspection target using consecutive frames of a gaze image.

6. The visual inspection confirmation device according to claim 3, wherein the processor is configured to detect a time period not related to visual inspection of the inspection target, and not to identify a point of inspection of the inspection target in the time period.

7. The visual inspection confirmation device according to claim 6, wherein the time period not related to the visual inspection of the inspection target is a time period in which an amount of change in the visual field image is greater than or equal to a threshold.

8. The visual inspection confirmation device according to claim 6, wherein the time period not related to the visual inspection of the inspection target is a time period in which an amount of change in a line of sight is greater than or equal to a threshold.

9. The visual inspection confirmation device according to claim 6, wherein the time period not related to the visual inspection of the inspection target is a time period in which an amount of change in the motion of the head is greater than or equal to a threshold.

10. The visual inspection confirmation device according to claim 1, wherein the processor is configured to compare a point of inspection which continues to be inspected for longer than or equal to a certain time with the work procedure information in time series.

11. The visual inspection confirmation device according to claim 2, wherein the processor is configured to compare a point of inspection which continues to be inspected for longer than or equal to a certain time with the work procedure information in time series.

12. The visual inspection confirmation device according to claim 3, wherein the processor is configured to compare a point of inspection which continues to be inspected for longer than or equal to a certain time with the work procedure information in time series.

13. The visual inspection confirmation device according to claim 4, wherein the processor is configured to compare a point of inspection which continues to be inspected for longer than or equal to a certain time with the work procedure information in time series.

14. The visual inspection confirmation device according to claim 5, wherein the processor is configured to compare a point of inspection which continues to be inspected for longer than or equal to a certain time with the work procedure information in time series.

15. The visual inspection confirmation device according to claim 6, wherein the processor is configured to compare a point of inspection which continues to be inspected for longer than or equal to a certain time with the work procedure information in time series.

16. The visual inspection confirmation device according to claim 7, wherein the processor is configured to compare a point of inspection which continues to be inspected for longer than or equal to a certain time with the work procedure information in time series.

17. The visual inspection confirmation device according to claim 8, wherein the processor is configured to compare a point of inspection which continues to be inspected for longer than or equal to a certain time with the work procedure information in time series.

18. The visual inspection confirmation device according to claim 10, wherein the processor is configured to compare a point of inspection which continues to be inspected for a period greater than or equal to a first threshold time and less than or equal to a second threshold time with the work procedure information in time series.

19. The visual inspection confirmation device according to claim 1, wherein the processor is configured to output a point of inspection which deviates from the work procedure information, as the result of comparison.

20. A non-transitory computer readable medium storing a program causing a computer to execute a process comprising:
inputting a visual field image of an inspector who visually inspects an inspection target;
inputting line of sight information on the inspector;
identifying points of inspection in the inspection target of the inspector in time series from the visual field image based on the line of sight information;
comparing the identified points of inspection with predetermined work procedure information in time series; and
outputting a result of comparison.
